(19) United States
(12) Patent Application Publication
(10) Pub. No.: US 2009/0107562 A1
(43) Pub. Date: Apr. 30, 2009

(54) Pre-pressurized self-balanced negative-pressure-free water-supply apparatus

(76) Inventor: Ruibo Wang, Oak Park, CA (US)

Correspondence Address: RUIBO WANG, 404 OAK HAVEN COURT, OAK PARK, CA, 91377, US

(21) Appl. No.: 11/926,264

(22) Filed: Oct. 29, 2007

(51) Int. Cl. F16L 5/00

(52) U.S. Cl. 137/357

(57) ABSTRACT

A water supply apparatus with self-balanced inlet pressure without negative pressure is described, which includes a tank, an air pump, a water pump, a micro-processor based automatic control unit, pressure sensors, level sensors, unidirectional valve. Features of this new design include dual cavity storage tank and air activated pressure stabilizer. In the tank a pre-pressed gas is contained. The pressure is maintained using a self-balanced pressure stabilizer. There is no need to add environmental air. Subsequently, environmental air related pollution is avoided.

A water supply apparatus with self-balanced inlet pressure without negative pressure is described, which includes a tank, an air pump, a water pump, a micro-processor based automatic control unit, pressure sensors, level sensors, unidirectional valve. Features of this new design include dual cavity storage tank and air activated pressure stabilizer. In the tank a pre-pressed gas is contained. The pressure is maintained using a self-balanced pressure stabilizer. There is no need to add environmental air. Subsequently, environmental air related pollution is avoided.

### FIELD OF TECHNOLOGY

This invention is related to a water supply apparatus for high-rise buildings, especially a booster apparatus that can be connected directly to a municipal water supply network.

### BACKGROUND OF THE INVENTION

A rubber bladder type pressure enhancement apparatus is available in the market. This apparatus consists of a gas tank, water pump, valve and electrical control unit. Features of this apparatus include, rubber bladder type gas tank acts as pressure stabilizer and buffer, and a gas is used as energy storage and buffer medium. With the isolation function of the rubber bladder, the pressure loss problem due to air dissolving into water is solved. Consequently, reliability of the water supply apparatus can be raised greatly. However, the rubber bladder gas tank is connected to the outlet of the water pump. So the apparatus can only be applied when a pool or well is used as the water source. It cannot be connected directly to the municipal water supply network. In order to boost the water pressure and provide water to high-rise buildings, a water supply apparatus has been invented without negative pressure. The main advantage of this apparatus is that it can be connected to the municipal water supply network without introducing negative pressure to the network. It can use the original pressure in the network, and avoid the pollution when water pool is applied. Therefore, it's an appropriate approach to water supply of high rise buildings.

In the apparatuses described above, in order to avoid the occurrence of negative pressure, air is added to the system. Whenever the air inlet is open, air is introduced to the water supply system. Since the air in the system has direct contact with the water, contamination caused by the air is inevitable.

The main purpose of this invention is to provide a solution to address the issue described above. In this approach the dual-cavity storage tank design and automatic gas activated pressure stabilizing device are employed. In the dual-cavity storage tank a certain gas is filled in, the storage tank is isolated from the atmosphere. In this way the air is totally isolated from water. Therefore, contamination is avoided. When the apparatus is in use, water pressure stabilization without negative pressure is realized through automatic gas pressure balance mechanism. There is no need to add air to eliminate negative pressure. So the air induced contamination is avoided.

### BRIEF DESCRIPTION OF THE DRAWING

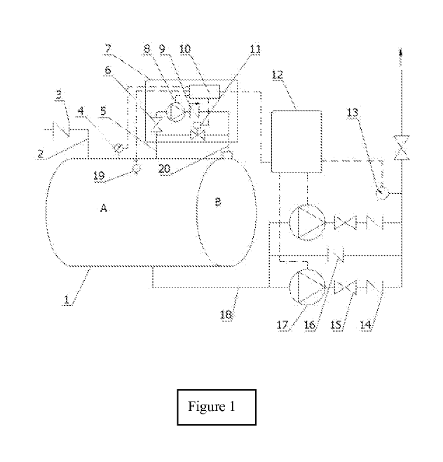

An embodiment example of this design is shown in FIG. 1.

1) Body of the tank; 2) Water inlet; 3) Check valve; 4) Water pressure sensor; 5) Gas pipe; 6) Gate valve; 7) Automatic gas activated self-pressure balancing device; 8) Air pump 9) Check valve; 10) Automatic control unit; 11) Magnetic valve 12) Micro-processor inverter control unit; 13) Pressure sensor; 14) Check valve; 15) Gate valve; 16) Check valve; 17) Water pump; 18) Pipe; 19) Level switch; 20) Gas pipe.

### DETAIL DESCRIPTION OF THE INVENTION

Referring to FIG. 1, detailed implementations of this invention is described as the follows.

Tank body (1) is divided into two cavities, cavity A and cavity B. Upper part of the tank body (1) is connected to water inlet pipe (2), gas pipe (5) and gas pipe (20). Upper part of the tank body (1) is also equipped with pressure sensor (4) and level switch (19). Lower part of tank body (1) is connected to pipe (18) and gas activated pressure stabilization device consisting of gate valve (6), gas pump (8), check valve (9), automatic control unit (10) and magnetic valve (11). Automatic valve (11), air pump (8), pressure sensor (4) and level switch (19) are wired with automatic control unit (10). The automatic gas activated pressure stabilization device (7) is connected with cavity A of tank body (1) through gas pipe (5), as well as cavity B through gas pipe (20). Inlet of water pump (17) is connected with cavity A of tank body (1). Outlet of water pump (17) is equipped with gate valve (15) and check valve (14). Check valve (16) is equipped in the pipe parallel to the water pumps. Pressure sensor (13) is mounted on the main outlet pipe. Electric motor of water pump (17) and pressure sensor (13) are wired with microprocessor inverter control unit. Automatic control unit (10) is also wired with microprocessor inverter control unit (12). Furthermore, check valve (3) is equipped in inlet pipe.

Build up of the pre-pressure: before applications of the equipment: replace the air in cavity A and B with a specific gas, and then seal the connectors. Setting of the pressure of the gas is dependent on the water pressure. Generally, the pressure is set at a value between 0.01 MPa and 0.02 MPa. Once the gas is filled. The pre-pressure condition will be established.

Principle of automatic gas pressure stabilization device (7): before the equipment is started, a pressure value is firstly chosen, which is noted as F which is usually ⅓ to ½ of the water pressure at peak usage. In the automatic control unit (10) this value is set as the action threshold of gas pump (8), which is noted as C1. Subtract a modification value Δ F from F, where Δ F is between 0.005 MPa and 0.02 MPa. (F-Δ F) is set as the action threshold of magnetic valve (11), which is noted as C2. After these action thresholds are set, the apparatus is ready to start. Remote pressure gauge (4) transmits the pressure information to the automatic control unit (10). Then the automatic control unit (10) compares the pressure signal with the threshold. If the pressure in cavity A is higher than the threshold C1, the automatic control unit (10) will turn on the gas pump (8). Since magnetic valve (11) is in the OFF state, the gas contained in cavity A will be compressed into cavity B through check valve (9) and pipe (20). Consequently, the pressure in cavity A will drop. Once the pressure in cavity A lowers to action threshold C1, automatic control unit will turn off gas pump (8). Then because of check valve (9), gas contained in cavity (8) will not be able to return to cavity A, and hence the pressure in cavity A is maintained at C1 or the stabilized value F. When the pressure in cavity A is lower than threshold C2, automatic control unit (10) turns on magnetic valve (11). At this moment, gas pump (8) is in the OFF state, and the gas contained in cavity B will be released to cavity A through pipe (20) and pipe (5). Then the pressure in cavity A will be increased. Once the pressure is raised to threshold C2, automatic control unit (10) turns off magnetic valve (11). So the pressure in cavity A is stabilized. During this process, the pressure in cavity A is maintained at a relatively stable value, the fluctuation range is A F. The setting of Δ F is to provide a buffer function which can prevent the gas pump (8) and magnetic valve (11) from interfering with each and causing un-necessary repeated actions. A F can be manually set according the system requirements.

The following is the whole process of water supply apparatus without negative pressure:

When the water pump (17) is controlled by the microprocessor inverter control unit (12) to provide users with a constant pressure, water from municipal network enters the water supply apparatus through water inlet.

When the inlet flow is higher than the supply flow, because the pressure setting for cavity A is lower than the water pressure, some of the water will be filled into cavity A. So the pressure in cavity A will be raised due to the compressed air. When the pressure is higher than setting C1, gas activated pressure stabilizing device (7) will be started and transfer the gas from cavity A to cavity B. During this period water level in cavity A increases gradually. When the cavity is fulfilled with water, level switch will send OFF indication to automatic control unit (10). Automatic control unit turns off gas pump (8). This ends the water storage phase. Function of check valve (3) is to avoid back flow and pollution in the municipal network.

When the inlet flow is lower than the system's supply flow, or the inlet flow totally stops, water stored in cavity A will be supplied to pump (17) through pipe (18) and supplied to users after being boosted by pump (17). In this way the low pressure in the municipal network is compensated and the users' pressure requirements are satisfied. When water level drops to threshold C2, gas activated automatic pressure stabilizing device starts working. Thus gas contained in cavity B will be transferred to cavity A in order to maintain the pressure in cavity A at the setting value. When water stored in cavity is exhausted, reading of the pressure sensor (13) will decrease. When the pressure lowers down to the setting value, microprocessor inverter control unit (12) will turn off the pump based on the pressure information. Then water pump (17) stops working in order to prevent the occurrence of negative pressure in network or damaging the pump due to operating in a waterless condition.

In conclusion, during all the working phases, pressures in cavity A and B are well maintained being positive, through the automatic pressure stabilization property of the pre-stored gas cavities. Therefore negative pressure cannot take place in the network.

The description above is an example-preferred embodiment of this invention. Variations based on the same principle are also considered being covered by this application.

1. An inlet pre-pressure stabilized water supply apparatus without negative pressure, which is composed of tank body (1), inlet pipe (2), pressure sensor (4), gas activated pressure stabilizing device (7), micro-processor automatic inverter control unit (12), pressure sensor (13), water pump (17), check valve (14), check valve (16), level switch (19). Features include: tank body (1) consists of two cavities, cavity A and cavity B. Top of the tank body (1) are connected to gas pipe (5) and gas pipe (20). Gas activated pressure stabilization device (7) is connected to cavity A tank body (1) through gas pipe (5), as well as cavity B through gas pipe (20).

2. An inlet pre-pressure stabilized water supply apparatus without negative pressure as defined in claim 1 has the following feature: inlet of water pump (17) is connected to cavity A of tank body (1) through pipe (18).

3. An inlet pre-pressure stabilized water supply apparatus without negative pressure as defined in claim 1 has the following feature: gas activated pressure stabilization device (7) consisting of gate valve (6), gas pump (8), check valve (9), automatic control unit (10) and magnetic valve (11).

4. An inlet pre-pressure stabilized water supply apparatus without negative pressure as defined in claim 1 includes a check valve equipped in inlet pipe (2).

5. An inlet pre-pressure stabilized water supply apparatus without negative pressure as defined in claim 1 shows the following feature: the outlet of water pump (17) is equipped with gate valve (15) and check valve (14).

6. An inlet pre-pressure stabilized water supply apparatus without negative pressure as defined in claim 1 includes a check valve in the pipe parallel with the water pump.

7. An inlet pre-pressure stabilized water supply apparatus without negative pressure as defined in claim 1 has a water pressure sensor mounted in the main outlet pipe.
